(19) United States
(12) Patent Application Publication
(10) Pub. No.: US 2011/0163884 A1
(43) Pub. Date: Jul. 7, 2011

(54) EMERGENCY EVENT DETECTOR

(76) Inventors: Alex Tame, Berkshire (GB); Robert Edward Banks, Berkshire (GB)

(21) Appl. No.: 12/737,418

(22) PCT Filed: Jul. 10, 2009
(86) PCT No.: PCT/GB2009/050819

§ 371 Date: Mar. 21, 2011

(30) Foreign Application Priority Data
Jul. 10, 2008 (GB) 0812647.6

(51) Int. Cl. G08B 21/00; G01L 9/00

(52) U.S. Cl. 340/626; 73/723

(57) ABSTRACT

Through the use of an electro-acoustic transducer, a pressure wave of at least a predetermined intensity may be detected, such as one that may occur upon the activation of a vehicle's air bag. As the electro-acoustic transducer has a diaphragm that can be displaced under the influence of a pressure wave, the transducer can therefore be monitored for an event occurrence indicative of the pressure wave. This monitoring may involve passively monitoring an electrical connection of the transducer for an electrical signal of a predetermined level, such that the electrical signal is the event indicative of the pressure wave. The monitoring may involve passively monitoring a pressure switch, such that activation of the pressure switch is the event indicative of the pressure wave. Upon detection of the pressure wave event, a trigger signal may be output to an emergency notification device to instigate a communication regarding a possible emergency situation.

### FIELD OF THE INVENTION

The present invention relates to a system and method for detecting an event which results in the generation of a high intensity pressure wave, such as may occur from a vehicular accident event. More particularly, the present invention relates to an emergency communication device configured for operation in a vehicle and a method of operation of such a device.

### BACKGROUND TO THE INVENTION

As part of the European Union (EU) eSafety initiative, it is expected that all new cars sold in the EU from 2009 onwards will be fitted with an emergency notification device such as an “eCall terminal”. An eCall terminal is a device configured to generate an emergency call either manually by a vehicle occupant or automatically via activation of in-vehicle sensors when an accident occurs. When activated, the eCall device typically establishes an emergency voice call to a Public Safety Answering Point (PSAP), which is typically a regulated public authority or a private centre that operates with the authorisation of a relevant public authority. At the same time, data regarding the accident is sent to the PSAP operator receiving the call.

Further details on how eCall is intended to operate are provided at http://europa.eu/scadplus/leg/en/lvb/131103a.htm.

There are problems, however, in relation to the activation of eCall devices. It is currently proposed that dedicated eCall modules will be hardwired to a dedicated vehicle crash detector, which typically detects activation of the vehicle's air bags. This however, is not a simple or cheap system to implement, due to dedicated eCall devices and detectors being required.

There is therefore a need for an improved eCall facility.

### SUMMARY OF THE INVENTION

According to a first aspect of the present invention, there is provided a method of detecting a pressure wave of at least a predetermined intensity including: monitoring a transducer for an event occurrence indicative of the pressure wave, the electro-acoustic transducer having a diaphragm configured to displace under the influence of a pressure wave; and outputting a detection signal upon the event occurring.

According to a second aspect of the present invention there is provided a method of adapting an electro-acoustic transducer for detecting a pressure wave of at least a predetermined intensity including: associating a detector with an electro-acoustic transducer, the electro-acoustic transducer having a diaphragm configured to displace under the influence of a pressure wave; using the detector to monitor the transducer for an event occurrence indicative of the pressure wave of at least a predetermined intensity; and outputting a detection signal from the detector upon the event occurring.

Preferably the monitoring step includes passively monitoring at least one electrical connection of the transducer for an electrical signal of at least a predetermined level, such that the electrical signal is the event indicative of the pressure wave.

Alternatively or in addition, it is preferable that the monitoring step includes passively monitoring a pressure switch, such that activation of the pressure switch is the event indicative of the pressure wave.

These aspects of the invention utilize electro-acoustic transducers in a reverse manner to which they were intended. That is, it is recognized pressure waves will have a reverse effect on loudspeakers and the like, to the extent that an electrical signal or pulse will be generated of a magnitude corresponding to the magnitude of the incident pressure wave. Therefore, by passively monitoring speakers for the occurrence of electrical signals of a suitable magnitude, then it becomes possible to detect extraordinary events, such as the activation of a vehicle's air bag(s), which are known to generate an exceedingly high intensity pressure wave.

Speakers may be incorporated into a vehicle with a view to being used for these two purposes. Alternatively, these aspects of the invention can make use of existing apparatus, without requiring dedicated detection equipment to be utilised. For instance, existing apparatus can be used, such as a car radio loudspeaker and/or a mobile phone's earpiece, in order to detect the sound pressure waves generated by air-bag inflation even where such equipment was never intended to be used as a microphone.

According to a further aspect, the present invention provides a mobile telecommunications terminal configured for use in transmitting an emergency communication including activation means configured to: activate the terminal according to a first procedure or a second procedure upon receipt of a trigger signal when the terminal is in a dormant state; and select the second procedure to activate the terminal when an over-discharge protection flag is set, such that the second procedure is of a shorter duration than the first procedure.

This aspect of the invention utilizes the existence of residual charge in a mobile terminal's battery, even after the terminal has been turned off in order to protect the battery from over-discharge. This allows the mobile terminal to be utilized in the transmission of an emergency communication, specifically as a detector of a emergency event (such as an air bag activation) and/or for wirelessly transmitting the emergency communication.

Other aspects of the invention are described in the attached set of claims.

### BRIEF DESCRIPTION OF THE DRAWINGS

For a better understanding of the present invention embodiments will now be described by way of example, with reference to the accompanying drawings, in which:

FIG. 1 illustrates the detection of an airbag pressure wave using a loudspeaker of a phone or car radio according to an embodiment of the present invention;

FIG. 2 illustrates an example of a detector circuit according to an embodiment of the present invention;

FIG. 3 illustrates an example of a loudspeaker that may be used as an air pressure switch according to an embodiment of the present invention;

FIG. 4 illustrates an example of an electrical connection for a pressure switch that can be used in relation to embodiments of the invention; and

FIG. 5 is a table of sound levels of various events, together with corresponding sound pressure and sound intensity measurements.

In the drawings like elements are generally designated with the same reference sign.

### DETAILED DESCRIPTION OF EMBODIMENT OF THE INVENTION

In a first embodiment of the invention, an existing in-vehicle device, such as the car radio loudspeaker, is utilised to detect an air bag activation event.

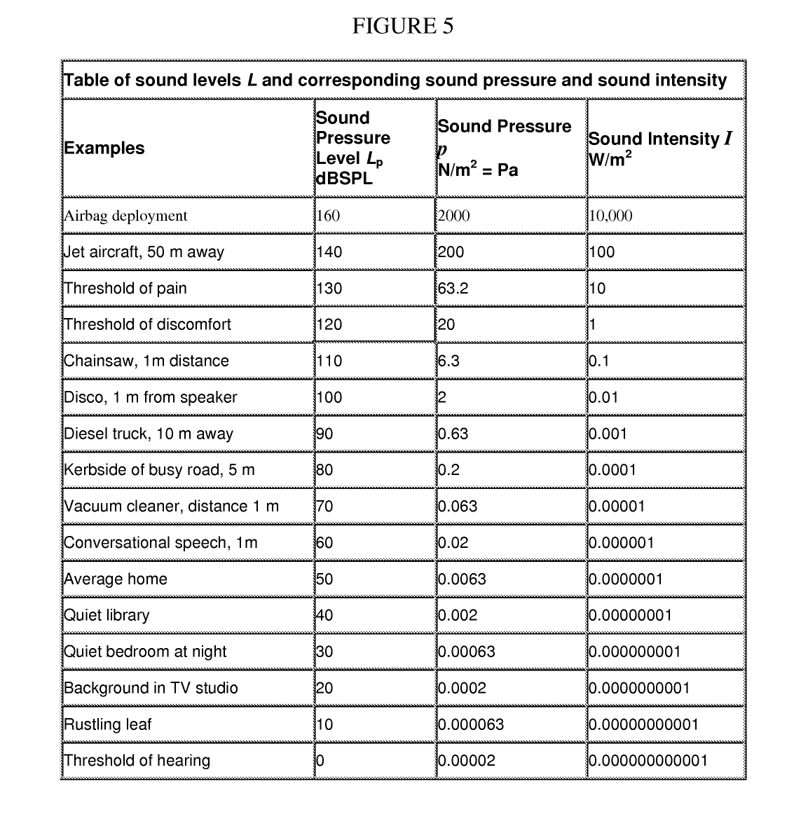

The release of an air bag generates a very loud acoustic pulse. The intensity of this pulse is evident by referring to FIG. 5.

FIG. 5 provides an illustration of the strength of the sound pressure wave that is generated from the deployment of an air bag, and provides a comparison with a number of other situations, from a jet aircraft, 50 metres away, to the threshold of hearing. The table shows that airbag deployment has a sound pressure level of 160 dBa, which corresponds to a sound intensity of 10,000 W/m2. This is greater than even the jet aircraft, 50 metres away, which has a sound pressure level of 140 dBa and a sound intensity of 100 W/m2.

The present embodiment of the invention utilises the fact that the pressure wave generated by an air bag deployment event is so intense, that nearby electro-acoustic transducers, such as a car radio loudspeaker, would produce a detectable signal. Advantageously, the present invention is able to make use of this signal even if the apparatus, with which the electro-acoustic transducer is associated, is switched off at the time.

In this regard, a key aspect of this embodiment of the invention is in the recognition that a detectable signal can be utilised from an electro-acoustic transducer, regardless of whether or not the speaker is in use. In other words, this embodiment of the invention utilises the fact that an acoustic sound wave will have an effect on speakers, in a reverse manner to which they are intended to be utilised (i.e. speakers are intended to convert electrical signal to acoustic sound waves and not the reverse).

To show that a detectable signal would be generated, for a speaker with an 8 cm diameter, the effective speaker area (A) is about 50 cm2. For an air bag deployment situation, with a sound intensity (I) of 10,000 W/m2 (see FIG. 5), the peak acoustic energy (P) that would be received for such a speaker would be:

P=I×A=10000×50×(10⁻²)²=50 W (1)

With the speaker operating at an efficiency of 1%, this would result in an electrical energy of 0.5 W.

With a speaker/electrical connections resistance of 8 ohms, the root mean square (RMS) voltage that this would generate would be:

V=√(P×R)=√(0.5×8)=2 Vᵣₘₛ (2)

This would correspond to a peak voltage of about 3V, which is readily detectable by a passive detector circuit.

As a comparison, by performing these same calculations as per equations (1) and (2) for the noise from a jet aircraft 50 metres away and a disco a metre from the speaker (see FIG. 5), the corresponding RMS voltages would be of the order of 0.2Vᵣₘₛ and 2×10⁻³ Vᵣₘₛ respectively. The differences between these situations show that an airbag deployment event can be readily differentiated from other “noise” events.

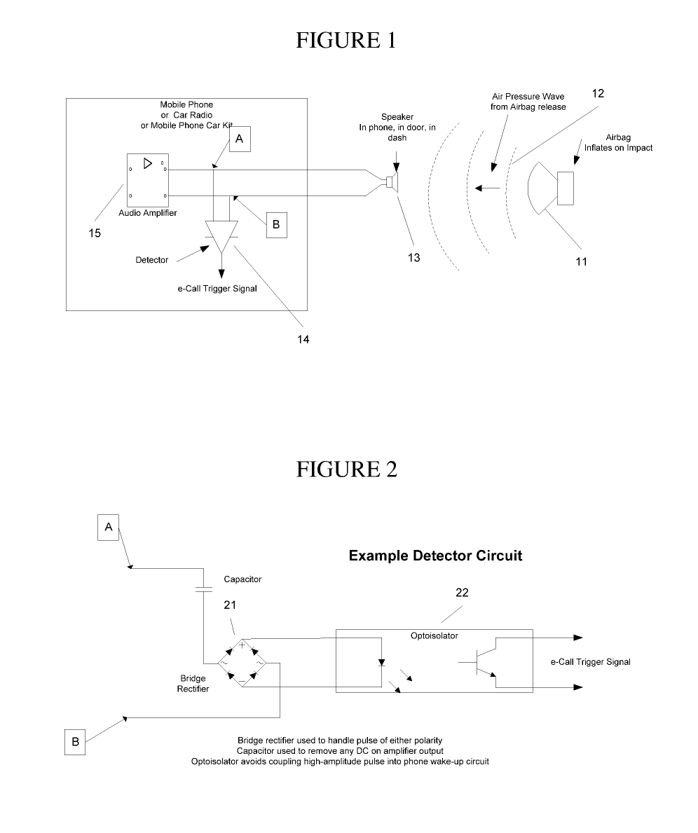

An example passive arrangement for detecting the pressure wave is illustrated in FIG. 1. In the event of an accident, the air bag 11 inflates on impact. The force of the air bag deployment generates an air pressure wave 12. This air pressure wave in turn will cause any speakers 13 in the vehicle to vibrate. These speakers may be located, for example, in the dashboard and/or the vehicle doors. The vibration of the speaker 13 in turn causes an electric signal to be generated. By placing a detector 14 across the speaker's electrical connections at points A and B, it is possible to detect when an electric signal of suitable strength occurs. This detector preferably has a threshold activation level in order to ensure that other events do not inadvertently initiate an emergency call.

In this regard, it is to be appreciated, with particular reference to FIG. 5 and the calculations made in relation to equations (1) and (2), that due to the high intensity of an air bag deployment event, other loud noises, particularly those that may be associated with a vehicle, such as a car door slamming, can be readily discriminated against, so that such events should not inadvertently activate the emergency notification device (e.g. the eCall device).

In the example arrangement of FIG. 1, it can be seen that the detector 14 can be placed across an existing speaker's electrical connections independently of any other component to which the speaker is attached, such as the vehicle's radio/audio amplifier 15. Therefore, the detector 14 is able to function without the need for the audio amplifier 15 to be switched on.

An example configuration of the detection 14 is illustrated in FIG. 2. A bridge rectifier 21 is placed between the connections leading off points A and B of the speaker's electrical connectors. This rectifier 21 converts pulses of either polarity to positive pulses which are fed to an electrical isolation component, such as the optical isolator 22. The optical isolator 22 is a semiconductor device that that allows signals to be transferred between different circuits or systems, while keeping those circuits or systems electrically isolated from each other. In this regard, the optical isolator 22 is being used to avoid any high amplitude pulses entering the detector 14 being coupled into subsequent circuitry, such as the eCall device itself. The optical isolator 22 therefore ensures that only signals of appropriate amplitude are forwarded. The signal that is output from the optical isolator 22 serves as the trigger signal for the eCall device.

The eCall device, upon receiving the trigger signal, operates in the usual manner, by initiating a call to an emergency call centre. Preferably, in instigating the call, the eCall device uses a shortened call set-up procedure to bypass authentication and provide a more rapid delivery of the emergency call.

A particular advantage of this embodiment of the invention is it enables an existing electro-acoustic transducer, such as is used in a car radio/stereo system, to be upgraded to provide acousto-electric transducer functionality. This allows eCall devices to be retrofitted to older cars as well as new cars, at less expense, since a dedicated “accident” sensor is not required. Further existing components may be utilised in the fitting of the eCall device, including the vehicle radio's transceiver and/or antenna for wireless transmitting the eCall.

It will be appreciated that in this embodiment, the detector 14 is a simple detector that discriminates between signals purely on absolute signal amplitude. That is, the bridge rectifier 21 will convert an alternating current signal into a pulsed direct current signal whose absolute magnitude is proportional to the originally detected signal, and the optical isolator will generate a trigger signal dependent upon the absolute magnitude of the signal output by the bridge rectifier. There will be a minimum signal required to energise the optical isolator 22, which will be set by the forward voltage required to energise the Light-Emitting Diode (LED) contained within the optical isolator. Once this minimum signal is met, the optical isolator effectively acts as a switch, generating the trigger signal of magnitude independent of the signal output from the rectifier 21.

The bridge rectifier is one example of a rectifier that may be used, and other rectifiers, including full wave and half wave rectifiers, are within the scope of this embodiment of the invention. Further, the optical isolator is one example of a device that may be utilised to relay the trigger signal, and that other forms of devices/circuits are possible, such as electro-mechanical relays and digital switches, preferably with electrical isolation capabilities.

If the loudspeaker is low efficiency then normal audio signals from the amplifier might be comparable with the electrical signal generated by the air-bag deployment. However at least one solution would be to generate a reference voltage from the normal audio signals, and compare the loudspeaker terminal voltage with the reference. As shown earlier, the air-bag signal is so intense that this comparison is simple to achieve.

In a second embodiment of the invention, an electro-acoustic transducer from a mobile communications device, such as a mobile phone is used to detect an accident situation, typically an air bag activation event. In this embodiment of the invention, a detector, such as the one shown in FIG. 2 may be incorporated into the mobile phone. The detector is placed across electrical connections of one or more electro-acoustic transducers of the mobile phone. For example, the detector 14 may be placed across an inbuilt phone speaker, a speaker of a mobile phone car kit and/or a buzzer/alert speaker (e.g. for ringtones) of the device. In a detector 14 in a mobile terminal, the optical isolator device 22 will prevent any high amplitude pulses coupling into the phone's components, such as its wake-up circuit.

In terms of a detectable signal being able to be generated on such speakers of a mobile phone, considering the vehicle speaker example outlined above, which showed how an 8 cm diameter speaker could generate a 3V peak electrical signal from an air bag deployment event, a mobile phone speaker, although much smaller than typical vehicle speakers, are much more efficient (i.e. much greater than the 1% operating efficiency of larger vehicle speakers). For example, it is known that speech will typically generate a signal of 1 mV, so on the sound intensity differences (see FIG. 5), it is clear that an airbag pulse will generate a signal of the order of tens of volts.

The detector 14 will passively monitor electrical energy signals experienced across the speaker's electrical connections for a pulse of sufficient magnitude as an indication of air bag deployment, and accordingly an accident. As with the previous embodiment, it is to be appreciated that a detectable signal will be produced even if the phone and/or associated car kit is switched off. The detector 14 upon detecting such a pulse, will generate an eCall trigger signal.

To effect the subsequent eCall, the mobile terminal itself may be fitted with an eCall component, which initiates the eCall to the appropriate emergency call centre. In this regard, an upgrade would typically be required to the phone's firmware in order to allow the handset to make the eCall initiated by the trigger signal generated by the airbag pulse.

Alternatively, the mobile phone/terminal may be configured to communicate with an eCall device fitted in the vehicle. In this alternative, the mobile terminal will operate as a detector of the high pressure wave indicative of an emergency event, and generate the trigger signal. This trigger signal would then be transmitted, such as via Bluetooth, to the eCall device. The external eCall device would typically be fitted into a vehicle.

If the handset is already switched on (e.g. in idle mode or active mode), then triggering the eCall is straightforward, since the emergency trigger can be immediately directed to the eCall device.

If the handset is switched off, the detector 14, since it is a passive detector, will still detect the signal generated by the airbag pulse but the trigger signal that is generated will first need to be directed to a phone “wake-up” circuit. In this regard, when a phone is switched off, it is effectively dormant, with some internal functionality being maintained, such as clock and alarm functions. Once the phone has been woken up using the trigger signal, the trigger signal may then be used to implement the emergency call.

It is to be further appreciated that the eCall device may be integrated into the mobile terminal itself, and that existing components of the mobile terminal may be utilised in integrating the eCall device therein, including the mobile phone's transceiver and/or antenna for wireless transmitting the emergency call

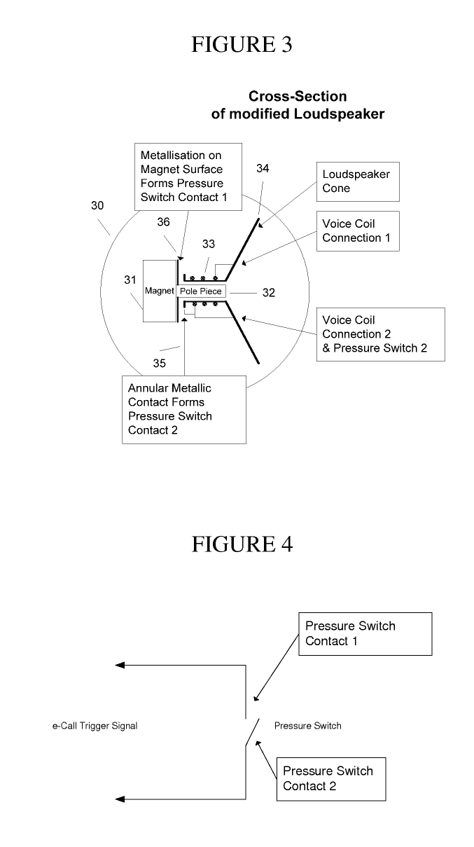

According to a further embodiment of the invention, rather than utilizing a detector circuit in relation to an existing electro-acoustic transducer to detect the air bag activation event, a modified speaker is provided. In this regard, with reference to FIG. 3, a cross section of a modified loudspeaker according to an embodiment of the invention is depicted.

In FIG. 3, the speaker is associated with a pressure switch. The pressure switch is configured to provide a trigger signal to an eCall device, when a sound wave of an appropriate pressure is applied to the speaker.

In this regard, the speaker 30 is an electro-acoustic transducer that converts electrical signals to sound wave. The speaker 30 includes a permanent magnet 31 with a pole piece 32. The pole piece 32 is surrounded by an electro-acoustic coil 33, often described as a voice coil. Alternating current electrical signals applied to the voice coil 33 cause it to generate an alternating magnetic field, which in turn affects the direction of repulsion and attraction of the coil 33. In this way, an applied alternating current constantly reverses the magnetic forces between the coil and the pole piece, which causes the coil to move back and forth in conformity with the applied signal. The electro-acoustic coil 33 is in turn associated with a cone or diaphragm 34. The rapid movement of the coil 33 causes the cone 34 to also move rapidly, thereby vibrating air in front of the speaker and creating sound waves.

This speaker construction will also be affected by externally generated acoustic waves, in that an external pressure wave will push the loudspeaker cone inwards.

To harness this pressure wave as a trigger for an emergency notification device (e.g. an eCall device), according to this embodiment of the invention a pressure switch is integrated into the speaker construction. In this regard, the inward end 35 of the coil 33 is fitted with a contact, preferably a metallic contact. A second contact 36 is formed on the magnet surface. This second contact may be formed using metallization and be connected via a suitable wire to an eCall device. In view of the coil surrounding the pole piece, the first contact 25 is preferably annular in shape.

In use, when a pressure wave of a strength corresponding to an air bag release arrives at the cone 34, it will cause the cone, and correspondingly the coil 33, to be displaced inwardly. This displacement will therefore cause the first contact 35, at the end of the coil 33 to move towards the second contact 36. By positioning the end of the coil at a distance corresponding to the expected displacement of the coil from an air bag activation event, the first contact 35 will be driven into mechanical contact with the second contact 36 thereby completing the circuit of the pressure switch (see FIG. 4) and causing an electrical signal to be generated. This electric signal is then passed onto the eCall device to act as a trigger therefore.

It is important that the displacement between the first and second contacts is chosen so that contact between the two is only made in the event of a pressure wave of a strength corresponding to that expected from an airbag pressure wave. As can be seen from FIG. 5, this airbag pressure wave is far more intense than any normal sound, so false alarms should not be an issue.

The speaker described in relation to FIG. 3 is an example of a speaker construction that may be used. It is however to be appreciated that the exact construction shown, particularly in regard to the positioning of the magnets and the coil, is not essential to the invention, and that various alterations are possible.

According to a still further embodiment of the invention, an approach is provided, for using a microphone associated with a mobile terminal as a detector. Advantageously the approach is usable when the mobile phone has a discharged or “flat” battery.

In this regard, it is a system requirement, defined in the standards, that when a handset determines its battery to be “flat”, as defined by an end-of-discharge trigger point that it switches itself off. Before doing so, however, it will send a “detach” sequence to the mobile network. This “detach” sequence serves to notify the network that the handset is being switched off, so that the network can set an appropriate flag in the HLR, so that any incoming calls are routed to voicemail or other specified divert.

The present embodiment of the invention however, makes use of the fact that the terminal does not exhaust all the energy in its battery at this switch off point. That is, modern mobile phones have intelligent battery management, which includes an over-discharge protection feature.

This protection feature is necessary because if a battery is very deeply discharged, then its ability to recharge is impacted. In other words, rechargeable batteries have the property that their service lifetime (i.e. the number of charge/discharge cycles that can be obtained before the battery capacity drops to an unacceptable level) is impacted by the depth of discharge. Mobile terminals therefore have circuits which monitor the state of charge of the battery and flag when the normal end point is approaching. This is typically about 95-99% of capacity.

So, consider the example of a mobile phone having a typical battery life “talk time” of at least 180 minutes (this is a low estimate, as many of today's handset models can achieve up to 540 minutes in favourable conditions). The “end-of-discharge” shut down trigger point is typically chosen as being between 95% and 99% of total battery life. It is also to be appreciated that the energy required to send the detach sequence to the network is taken from the 1-5% of capacity that is left. Therefore, in order to ensure that this sequence is achieved, the end of service level is set conservatively.

Nevertheless, considering the worst case scenario of 99%, the remaining talk time at this point is:

180× 1/99=1.8 minutes. (3)

The time taken for an eCall to be made varies with circumstances, but it is estimated to be less than one minute, even in the extreme case of a handset being switched off and in another country, so that it appears as a roaming user when the eCall is initiated. In more favourable circumstances, the eCall set up sequence is measured in seconds, and thus should be easily achievable using the battery life actually remaining after a “flat” terminal's “end-of-discharge” stage.

Even if the handset has been left apparently discharged for some time, there should still be enough energy to start the terminal up and send the eCall.

In a preferred aspect of this embodiment of the invention, upon initiation of the start up sequence for an emergency eCall, where the over-discharge protection flag is set, indicating that the terminal was shut down due to the battery being “flat”, a reduced start up procedure will be implemented, which is not the same as the normal handset start up procedure. In this regard, the handset start up for an eCall proceeds straight to the network registration procedure, without displaying the usual start-up screens with operator logos and the like. This will help to further ensure that the eCall is able to be made within the confines of the remaining restricted battery life.

In a further preferred aspect of this embodiment of the invention, the eCall that is made differs from the standard eCall procedure. In this regard, again due to the remaining restricted battery life, a minimal eCall is made, in the event of an accident. In this regard, the minimal eCall may contain just the MSD, which is the Minimum Set of Data and typically includes the time, location and vehicle description. There is unlikely to be enough battery life for a voice call to be made to the emergency call centre, so an additional flag or message may be transmitted to communicate this, such as a message stating “no battery thus no voice”.

This aspect of the invention therefore makes use of the fact that in the majority of instances, the battery of a mobile phone is not at the end of its service life, and that a conservative implementation of “end of discharge” settings will lead to a reasonable amount of retained charge in the battery.

Whilst it is not good for a battery to be drained completely, in the event of a crash severe enough to trigger the air bag and potentially injure passengers, the need to protect the battery can be sacrificed in order to benefit the passengers. Thus this aspect of the invention effectively overrides the normal “end-of-discharge” monitoring and operates the battery in the deep discharge region in order to wake up the handset, activate the emergency notification device and send the emergency notification.

Preferably the emergency notification device is a component of the mobile terminal, such the notification device utilises the terminal's transceiver to send the emergency communication. Alternatively, it may be separate from the terminal, but in communicable relation thereto, such as via Bluetooth.

The terminal itself may be any terminal able to communicate using a mobile telecommunications network, and whilst particularly covering mobile phones, PDAs, portable computers with a wireless card and the like, is not to be considered limited to such.

The embodiments of the invention have been described in relation to an electro-acoustic transducer being adapted to detect a pressure wave, such as a sound or acoustic wave. The pressure wave is particularly applicable to one generated from the activation of a vehicle air bag, as described, but may also be generated by other high intensity events, particularly events indicative of an emergency event, such as the actual collision of a vehicle.

The electro-acoustic device may be of any form, provided it has a mechanism for directly or proportionally translating a pressure wave into movement and/or an electrical signal. Ideally this mechanism is a diaphragm or cone able to be vibrated by the pressure wave.

1. A method of detecting a pressure wave of at least a predetermined intensity comprising:
monitoring a transducer for an event occurrence indicative of the pressure wave, the electro-acoustic transducer having a diaphragm configured to displace under the influence of a pressure wave; and
outputting a detection signal upon the event occurring.

2. A method of adapting an electro-acoustic transducer for detecting a pressure wave of at least a predetermined intensity comprising:
associating a detector with an electro-acoustic transducer, the electro-acoustic transducer having a diaphragm configured to displace under the influence of a pressure wave;
using the detector to monitor the transducer for an event occurrence indicative of the pressure wave of at least a predetermined intensity; and
outputting a detection signal from the detector upon the event occurring.

3. The method of claim 1, wherein the monitoring step includes passively monitoring at least one electrical connection of the transducer for an electrical signal of at least a predetermined level, such that the electrical signal is the event indicative of the pressure wave.

4. The method of claim 1, wherein the monitoring step includes passively monitoring a pressure switch, such that activation of the pressure switch is the event indicative of the pressure wave.

5. The method of claim 1, wherein the pressure wave of at least a predetermined intensity is indicative of an accident event, and the method further comprising:
using the detection signal to trigger an emergency notification device.

6. (canceled)

7. (canceled)

8. A method of adapting an electro-acoustic transducer for pressure wave detection, the transducer having a diaphragm configured to displace under the influence of a pressure wave and the method comprising:
creating a first contact, such that the first contact is associated with the diaphragm; and
creating a second contact, separated from the first contact, such that upon the diaphragm being displaced by a predetermined displacement under the influence of an pressure wave, the first contact is configured to mechanically contact the second contact and thereby generate a signal indicative of the occurrence of the pressure wave.

9. A pressure wave detector configured for use with an electro-acoustic transducer having a diaphragm configured to displace under the influence of a pressure wave, the detector comprising:
a detection component configured for connection to at least one electrical connector of the transducer, in order to enable detection of an electrical signal of at least a predetermined level, such that the predetermined level of the electrical signal is indicative of a pressure wave of at least a predetermined intensity; and
an interface configured to output a trigger signal upon the detection of the electrical signal of at least the predetermined level.

10. The detector of claim 9 wherein the detection component is a rectifier configured to generate a detection signal, such that the detection signal has a rectified magnitude that is proportional to the magnitude of a detected electrical signal.

11. (canceled)

12. The detector of claim 9, wherein the transducer with which the detector is configured for use with is at least one of: a) a vehicular speaker; b) a speaker of a mobile phone; or c) a speaker of a mobile phone car kit.

13. An electro-acoustic transducer adapted for detecting a pressure wave, the transducer comprising:
a diaphragm configured to displace under the influence of a pressure wave;
a first contact associated with the diaphragm; and
a second contact, separated from the first contact, such that upon the diaphragm being displaced under the influence of an pressure wave by at least a predetermined displacement, wherein the first contact is configured to mechanically contact the second contact and thereby generate a signal indicative of the occurrence of the pressure wave.

14. The transducer of claim 13, further comprising:
a coil associated with the diaphragm, such that the first contact is attached to one end of the coil.

15. The transducer of claim 13, wherein the first contact is separated from the second contact by a distance corresponding to the predetermined displacement, the predetermined displacement corresponding to a minimum expected displacement of the coil by an pressure wave of a particular intensity.

16. A mobile telecommunications terminal configured for use in transmitting an emergency communication comprising:
an activation device configured to: activate the terminal according to a first procedure or a second procedure upon receipt of a trigger signal when the terminal is in a dormant state; and select the second procedure to activate the terminal when an over-discharge protection flag is set, such that the second procedure is of a shorter duration than the first procedure.

17. The mobile terminal of claim 16, further comprising:
a detection component configured to detect an emergency event and generate a trigger signal upon detection of the emergency event.

18. The mobile terminal of claim 17 wherein the detection component includes an electro-acoustic transducer configured to generate an electrical signal of at least a predetermined magnitude in response to the emergency event.

19-25. (canceled)

26. The method of claim 2, wherein the monitoring step includes passively monitoring at least one electrical connection of the transducer for an electrical signal of at least a predetermined level, such that the electrical signal is the event indicative of the pressure wave.

27. The method of claim 2, wherein the monitoring step includes passively monitoring a pressure switch, such that activation of the pressure switch is the event indicative of the pressure wave.

28. The method of claim 2, wherein the pressure wave of at least a predetermined intensity is indicative of an accident event, and the method further comprises:
using the detection signal to trigger an emergency notification device.
